(19) United States
(12) Patent Application Publication
(10) Pub. No.: US 2018/0278784 A1
(43) Pub. Date: Sep. 27, 2018

(54) COMMUNICATION CONTROL DEVICE AND COMMUNICATION CONTROL SYSTEM

(71) Applicant: FUJI XEROX CO., LTD., Tokyo (JP)

(72) Inventors: Masatoshi SUZUKI, Kanagawa (JP); Sakae OKAZAKI, Kanagawa (JP); Yuichi SUGIYAMA, Kanagawa (JP); Masahiro SUZUKI, Kanagawa (JP); Yoshiaki MORITA, Kanagawa (JP); Toshitsugu KIKUCHI, Kanagawa (JP); Yasunori ASADA, Kanagawa (JP); Shunsuke KASAHARA, Kanagawa (JP)

(73) Assignee: FUJI XEROX CO., LTD., Tokyo (JP)

(21) Appl. No.: 15/690,735

(22) Filed: Aug. 30, 2017

(30) Foreign Application Priority Data
Mar. 22, 2017 (JP) 2017-056420

(51) Int. Cl. H04N 1/00; H04N 1/32

(52) U.S. Cl. CPC H04N 1/00931; H04L 5/16; H04N 1/32587

(57) ABSTRACT

A communication control device includes a communication unit, a reception unit, and a controller. The communication unit transfers first image data obtained from a first processing device to an external control device for each portion among portions that are predetermined transfer units, and transfers second image data transferred from the external control device to a second processing device, the communication control device and the external control device being included in a system and being connected to each other via a communication line for half-duplex communication. The reception unit receives a signal that is transmitted during an interval between the portions of the first image data. The controller performs control so as to start obtaining the second image data transferred from the external control device in a case where the signal is received by the reception unit.

### CROSS-REFERENCE TO RELATED APPLICATIONS

This application is based on and claims priority under 35 USC 119 from Japanese Patent Application No. 2017-056420 filed Mar. 22, 2017.

### BACKGROUND

### Technical Field

The present invention relates to a communication control device and a communication control system.

### SUMMARY

According to an aspect of the invention, there is provided a communication control device including a communication unit, a reception unit, and a controller. The communication unit transfers first image data obtained from a first processing device to an external control device for each portion among portions that are predetermined transfer units, and transfers second image data transferred from the external control device to a second processing device, the communication control device and the external control device being included in a system and being connected to each other via a communication line for half-duplex communication. The reception unit receives a signal that is transmitted during an interval between the portions of the first image data. The controller performs control so as to start obtaining the second image data transferred from the external control device in a case where the signal is received by the reception unit.

### BRIEF DESCRIPTION OF THE DRAWINGS

Exemplary embodiments of the present invention will be described in detail based on the following figures, wherein:

FIG. 1 is a block diagram illustrating a configuration of a communication control system according to exemplary embodiments;

FIG. 2 is a diagram illustrating a configuration of a communication control system according to a first exemplary embodiment and a third exemplary embodiment;

FIG. 3A is a block diagram illustrating a principal configuration of an electrical system of a communication control device according to the first exemplary embodiment and the third exemplary embodiment;

FIG. 3B is a block diagram illustrating a principal configuration of an electrical system of an external control device according to exemplary embodiments;

FIG. 4 is a schematic diagram for describing an inter-page gap according to the first exemplary embodiment and the third exemplary embodiment;

FIG. 5 is a diagram illustrating a configuration of the communication control system according to the first exemplary embodiment and the third exemplary embodiment;

FIG. 6 is a schematic diagram for describing a transfer start timing of transfer C according to the first exemplary embodiment and the third exemplary embodiment;

FIG. 7 is a flowchart illustrating a program flow of a transfer control process according to the first exemplary embodiment and the third exemplary embodiment;

FIG. 8 is a diagram illustrating a configuration of the communication control system according to the first exemplary embodiment and the third exemplary embodiment;

FIG. 9 is a flowchart illustrating a program flow of a signal control process according to the first exemplary embodiment and the third exemplary embodiment;

FIG. 10 is a diagram illustrating part of a configuration of a communication control system according to a second exemplary embodiment;

FIG. 11 is a block diagram illustrating a principal configuration of an electrical system of a communication control device according to the second exemplary embodiment;

FIG. 12 is a schematic diagram for describing an inter-line gap according to the second exemplary embodiment;

FIG. 13 is a schematic diagram for describing a transfer start timing of transfer C according to the second exemplary embodiment;

FIG. 14 is a schematic diagram for describing a transfer start timing of transfer C according to the second exemplary embodiment;

FIG. 15 is a flowchart illustrating a program flow of a transfer control process according to the second exemplary embodiment; and

FIG. 16 is a flowchart illustrating a program flow of a determination process according to the third exemplary embodiment.

### DETAILED DESCRIPTION

Hereinafter, exemplary embodiments of the present invention will be described in detail below with reference to the attached drawings.

### First Exemplary Embodiment

First, a communication control device and a communication control system according to a first exemplary embodiment are described.

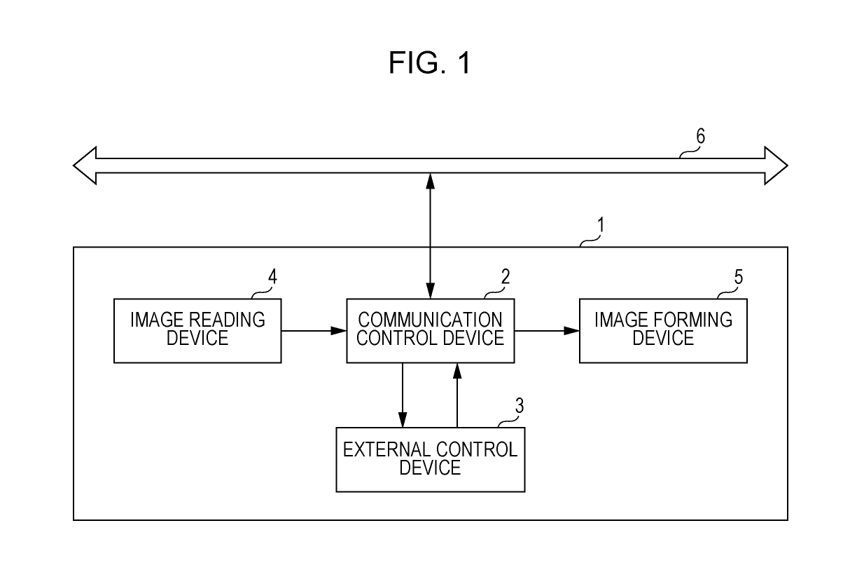

As illustrated in FIG. 1, a communication control system 1 according to this exemplary embodiment is an image forming system (that is, a printer) and includes a communication control device 2, an external control device 3, an image reading device 4, and an image forming device 5.

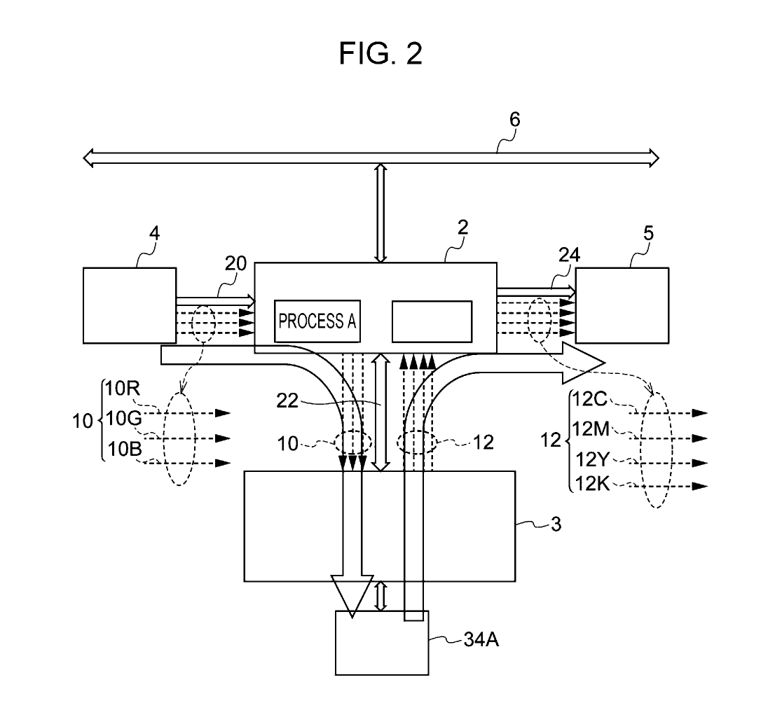

The communication control device 2 is connected to the image reading device 4 via a dedicated line 20 and obtains from the image reading device 4 first image data 10 that represents a read image, as illustrated in FIG. 2. The first image data 10 is image data represented on the basis of, for example, the RGB color model and is transferred for each color, that is, transferred as an R signal 10R, a G signal 10G, and a B signal 10B. The communication control device 2 is connected to the external control device 3 via a communication line 22 for half-duplex communication and transfers the obtained first image data 10 to the external control device 3. The communication line 22 for half-duplex communication is compliant with, for example, USB 2.0.

The communication control device 2 obtains second image data 12, which is generated by processing the first image data 10, from the external control device 3. The second image data 12 is image data that is represented on the basis of, for example, the CMYK color model and is transferred for each color, that is, transferred as a C signal 12C, an M signal 12M, a Y signal 12Y, and a K signal 12K. The communication control device 2 is connected to the image forming device 5 via a dedicated line 24 and transfers the obtained second image data 12 to the image forming device 5.

The communication control device 2 is connected to a network 6, which is, for example, the Internet, and communicates with an external device over the network 6.

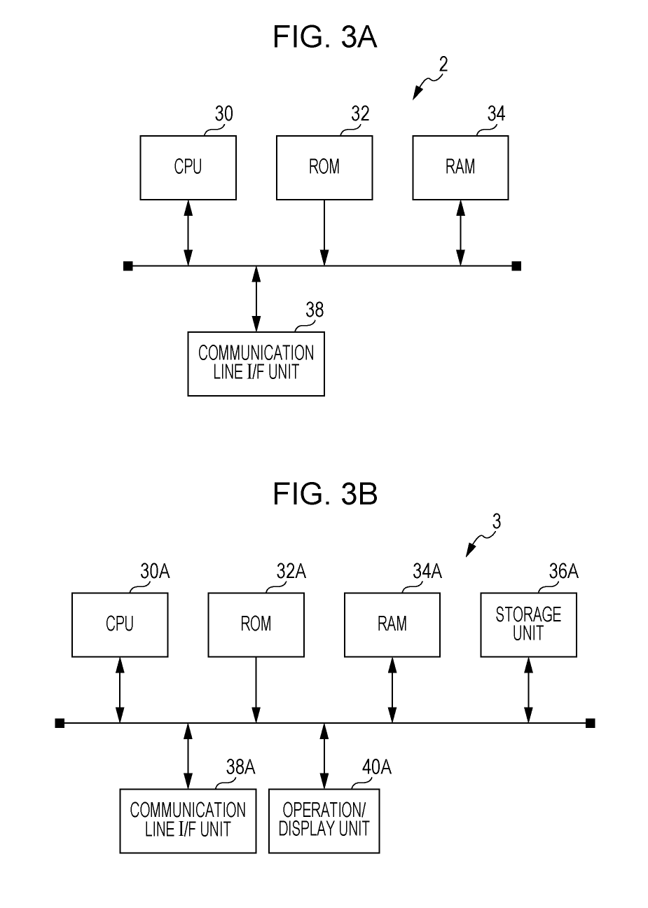

The communication control device 2 is controlled by a central processing unit (CPU) 30 that controls operations of the entire device, and is implemented, as illustrated in FIG. 3A. Specifically, the communication control device 2 includes the CPU 30, which is an example corresponding to a communication unit, a reception unit, and a controller, a read-only memory (ROM) 32 that stores in advance various programs, various parameters, and so on, and a random access memory (RAM) 34 that is used as a work area and so on for the CPU 30 to execute various programs. The communication control device 2 further includes a communication line interface (I/F) unit 38 for transmitting/receiving communication information to/from an external device over the network 6.

The external control device 3 obtains the first image data 10 from the communication control device 2 and processes the obtained first image data 10 into a data format for which the image forming device 5 is able to form an image to generate the second image data 12, as illustrated in FIG. 2. The external control device 3 transfers the second image data 12 obtained as a result of the processing to the communication control device 2.

The external control device 3 is controlled by a CPU 30A that controls operations of the entire device, and is implemented, as illustrated in FIG. 3B. Specifically, the external control device 3 includes the CPU 30A, a ROM 32A that stores in advance various programs, various parameters, and so on, a RAM 34A that is used as a work area and so on for the CPU 30A to execute various programs, and a storage unit 36A that includes a nonvolatile memory, such as a flash memory. The external control device 3 further includes a communication line I/F unit 38A for transmitting/receiving communication information to/from an external device. The external control device 3 further includes an operation/display unit 40A that receives instructions for the external control device 3 given by a user and communicates various types of information regarding the operation state and so on of the external control device 3 to the user. The operation/display unit 40A includes, for example, a touch panel display on which display buttons for receiving operation instructions and various types of information are displayed when a program is executed, and hardware keys, such as numeric keys and a start button.

The image reading device 4 is a scanner. The image reading device 4 reads an image formed on, for example, a recording medium and transfers the first image data 10 that represents the read image to the communication control device 2.

The image forming device 5 is a printer. The image forming device 5 obtains the second image data 12 from the communication control device 2 and forms an image on, for example, a recording medium on the basis of the obtained second image data 12.

Hereinafter, a transfer process performed by the image reading device 4 for transferring the first image data 10 that represents a read image to the communication control device 2 is called transfer A. A transfer process performed by the communication control device 2 for transferring the obtained first image data 10 to the external control device 3 is called transfer B. A transfer process performed by the external control device 3 for transferring the second image data 12 that is generated by processing the obtained first image data 10 into a data format for enabling the image forming device 5 to form an image to the communication control device 2 is called transfer C. A transfer process performed by the communication control device 2 for transferring the obtained second image data 12 to the image forming device 5 is called transfer D.

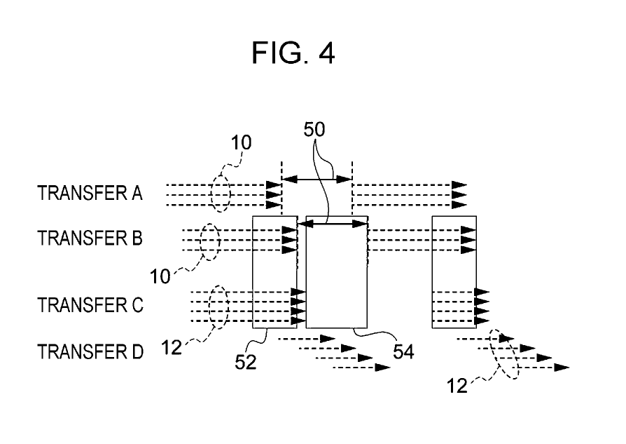

Here, in a case where the image reading device 4 successively reads images formed on plural recording media, there is a time period during which reading is not being performed in a period from completing reading of an image of one page until starting reading of an image of the next page. Accordingly, in transfer A between the image reading device 4 and the communication control device 2, there is an interval (hereinafter referred to as “inter-page gap”) 50 during which transfer A is not being performed between successive plural pieces of the first image data 10, as illustrated in FIG. 4.

The inter-page gap 50 also exists in transfer B between the communication control device 2 and the external control device 3 in a case where, in the process A in FIG. 2, image data from the image reading device 4 is not temporarily stored on the communication control device 2, is subjected to only a simple real-time process (for example, shading correction), and is output to the external control device 3. Accordingly, also in transfer B, when the first image data 10 is transferred from the communication control device 2 to the external control device 3 for each of the portions that are predetermined transfer units (in this exemplary embodiment, the transfer units correspond to the recording media), the inter-page gap 50 between the portions exists.

In this case, in order to reduce a load of communication between the communication control device 2 and the external control device 3, it is desirable to perform one of transfer B and transfer C. However, in a case where the first image data 10 and the second image data 12 are transferred without controlling the transfer timings of the first image data 10 and the second image data 12, there are a period 52 during which both transfer B and transfer C are performed and a period 54 during which transfer B or transfer C is not performed, as illustrated in FIG. 4, and a load of communication between the communication control device 2 and the external control device 3 increases.

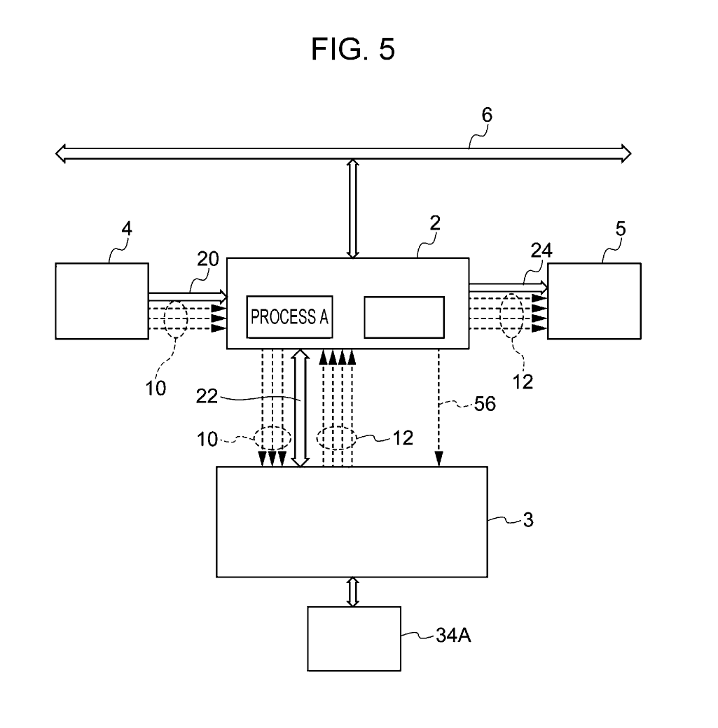

Accordingly, in this exemplary embodiment, a data transfer enable signal (hereinafter simply referred to as “enable signal”) 56 that is based on whether a transfer from the communication control device 2 to the external control device 3 is being performed and that indicates whether communication from the external control device 3 to the communication control device 2 is allowed is output, as illustrated in FIG. 5. The enable signal 56 used in this exemplary embodiment is made active during a period in which a transfer from the communication control device 2 to the external control device 3 is not being performed and indicates that communication from the external control device 3 to the communication control device 2 is allowed. The enable signal 56 used in this exemplary embodiment is made inactive during a period in which a transfer from the communication control device 2 to the external control device 3 is being performed and indicates that communication from the external control device 3 to the communication control device 2 is not allowed. The external control device 3 determines whether communication is allowed, that is, whether the external control device 3 may start data transfer from the external control device 3 to the communication control device 2, on the basis of the enable signal 56.

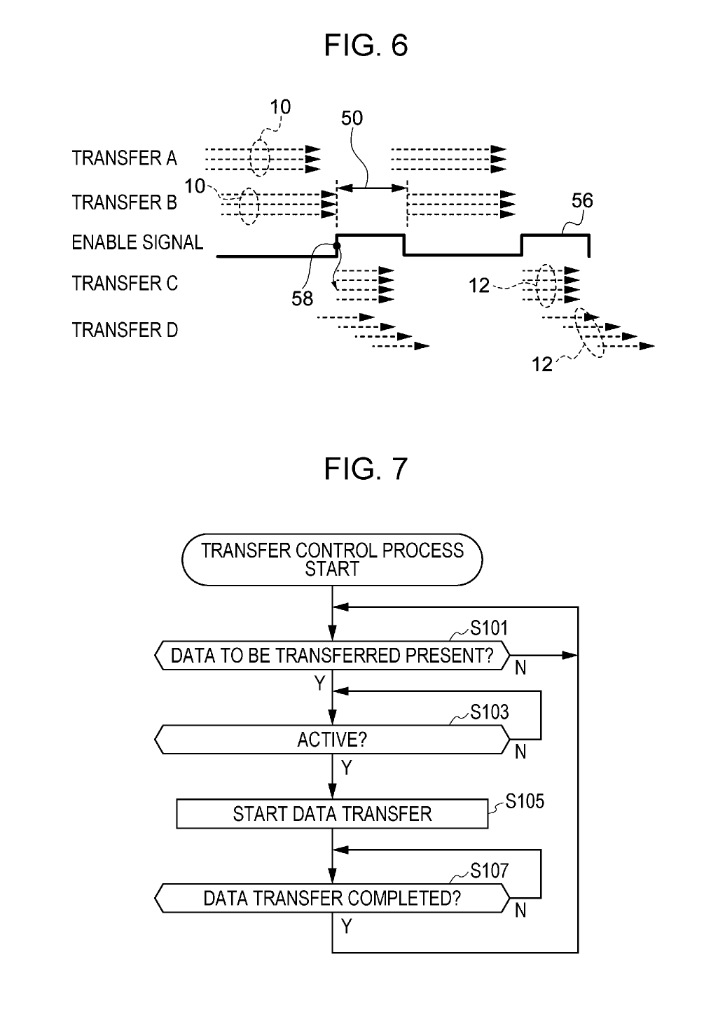

Specifically, the communication control device 2 makes the enable signal 56 active and outputs the enable signal 56 during the period of the inter-page gap 50 in which data transfer in transfer B is not being performed, as illustrated in FIG. 6. The external control device 3 starts transfer C, that is, a transfer of the second image data 12 from the external control device 3 to the communication control device 2, at the timing 58 when the enable signal 56 switches from inactive to active.

Accordingly, control is performed so as to start transfer C during the period of the inter-page gap 50 in which transfer B is not being performed, as illustrated in FIG. 6, and a load of communication between the communication control device 2 and the external control device 3 is reduced.

Note that, in this exemplary embodiment, transfer C is not necessarily completed within a period during which the enable signal 56 is active. That is, in this exemplary embodiment, it is assumed that, in a case where the period of the inter-page gap 50 is shorter than the transfer time of transfer C, a transfer in transfer C might not be completed within the period of the inter-page gap 50, and the next transfer in transfer B might be started while the transfer in transfer C is ongoing, and transfer B and transfer C may be simultaneously performed.

In a case where both the communication control device 2 and the external control device 3 allow a dedicated line to be provided, a dedicated line connecting the communication control device 2 and the external control device 3 is provided, and the enable signal 56 is output by using the dedicated line. Alternatively, in a case where a bidirectional signal of USB Type-C is used, for example, the alternate mode of USB Type-C is used to allocate an unused signal to the enable signal 56.

Now, a flow of a transfer control process that is performed by the external control device 3 according to this exemplary embodiment in a case where a predetermined instruction for performing is input is described with reference to the flowchart in FIG. 7. Note that, in this exemplary embodiment, a program for the transfer control process is stored in advance in the storage unit 36A; however, the program is not limited to this. For example, the program for the transfer control process may be received from an external device via the communication line I/F unit 38A and stored in the storage unit 36A. Alternatively, the program for the transfer control process recorded to a recording medium, such as a compact disc read-only memory (CD-ROM), may be read by, for example, a CD-ROM drive to thereby perform the transfer control process.

In step S101, the CPU 30A determines whether the second image data 12 to be transferred to the communication control device 2 is present. If the CPU 30A determines in step S101 that the second image data 12 to be transferred to the communication control device 2 is present (Y in step S101), the flow proceeds to step S103. If the CPU 30A determines in step S101 that the second image data 12 to be transferred to the communication control device 2 is not present (N in step S101), step S101 is repeated until the CPU 30A determines that the second image data 12 to be transferred to the communication control device 2 is present.

In step S103, the CPU 30A determines whether the enable signal 56 is active. If the CPU 30A determines in step S103 that the enable signal 56 is active (Y in step S103), the flow proceeds to step S105. If the CPU 30A determines in step S103 that the enable signal 56 is inactive (N in step S103), step S103 is repeated until the CPU 30A determines that the enable signal 56 is active.

In step S105, the CPU 30A starts a transfer of the second image data 12 to the communication control device 2.

Next, in step S107 the CPU 30A determines whether the transfer started in step S105 is completed. If the CPU 30A determines in step S107 that the transfer is completed (Y in step S107), the flow returns to step S101. If the CPU 30A determines in step S107 that the transfer is not completed (N in step S107), step S107 is repeated until the CPU 30A determines that the transfer is completed.

As described above, in this exemplary embodiment, the external control device 3 starts a transfer of the second image data 12 in the case where the enable signal 56 is switched to active. That is, the communication control device 2 starts obtaining the second image data 12 transferred from the external control device 3 in the case where the enable signal 56 is switched to active.

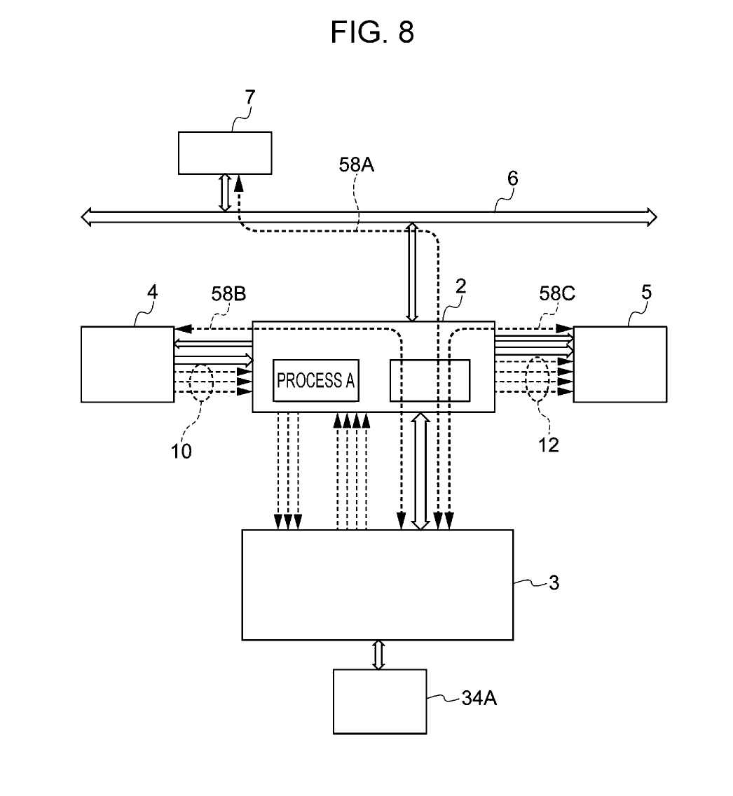

Here, in a case where a signal that is different from the first image data 10 and the second image data 12 is input to the communication control device 2, and the input signal is transferred to the external control device 3, as illustrated in FIG. 8, the signal is transferred to the external control device 3 during a period in which the enable signal 56 is active.

That is, in the system that is designed to allow transfer B and transfer C to be simultaneously performed, the data amount of a different signal as described above is sufficiently smaller than the data amount of the first image data 10 in transfer B. Therefore, when the signal is transferred to the external control device 3 during the period in which transfer B is not being performed, that is, during the period in which the enable signal 56 is active, a transfer of the first image data 10 and a transfer of the second image data 12 are not hindered by the transfer of the signal.

Examples of a signal different from the first image data 10 and the second image data 12 include image formation data 58A, the image formation data 58A being input to the communication control device 2 from an external device 7, which is, for example, a personal computer (PC), connected to the communication control device 2 and being used to give an instruction for image formation, error information (sensor information indicating a jam error and so on) 58B input to the communication control device 2 from the image reading device 4, and error information (sensor information indicating a jam error, paper out, tray open, and so on) 58C input from the image forming device 5, as illustrated in FIG. 8.

The communication control device 2 switches the enable signal 56 to inactive during a period in which the communication control device 2 is transferring a signal different from the first image data 10 and the second image data 12 to the external control device 3. Accordingly, the different signal is not transferred simultaneously with the first image data 10 from the communication control device 2 to the external control device 3.

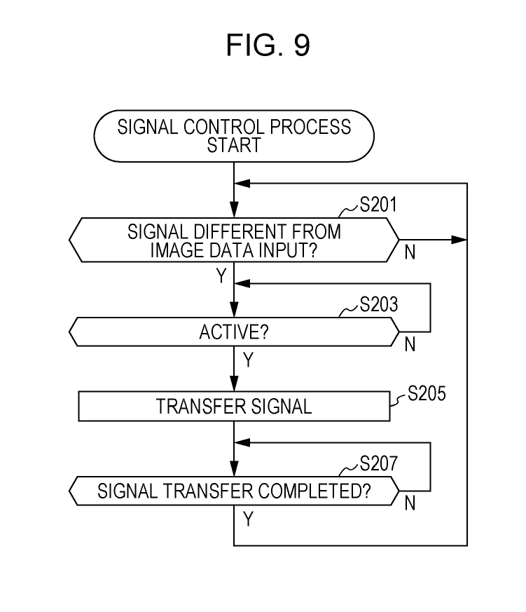

Now, a flow of a signal control process that is performed by the communication control device 2 according to this exemplary embodiment in a case where a predetermined instruction for performing is input is described with reference to the flowchart in FIG. 9. Note that, in this exemplary embodiment, a program for the signal control process is stored in advance in the ROM 32; however, the program is not limited to this.

In step S201, the CPU 30 determines whether a signal different from the first image data 10 and the second image data 12 is input to the communication control device 2. If the CPU 30 determines in step S201 that such a different signal is input (Y in step S201), the flow proceeds to step S203. If the CPU 30 determines in step S201 that such a different signal is not input (N in step S201), step S201 is repeated until the CPU 30 determines that such a different signal is input.

In step S203, the CPU 30 determines whether the enable signal 56 is active. If the CPU 30 determines in step S203 that the enable signal 56 is active (Y in step S203), the flow proceeds to step S205. If the CPU 30 determines in step S203 that the enable signal 56 is inactive (N in step S203), step S203 is repeated until the CPU 30 determines that the enable signal 56 is active.

In step S205, the CPU 30 starts a transfer of the input signal to the external control device 3.

Next, in step S207, the CPU 30 determines whether the transfer started in step S205 is completed. If the CPU 30 determines in step S207 that the transfer is completed (Y in step S207), the flow returns to step S201. If the CPU 30 determines in step S207 that the transfer is not completed (N in step S207), step S207 is repeated until the CPU 30 determines that the transfer is completed.

Note that, in the signal control process described above, the CPU 30 waits for the enable signal 56 to be active in step S203; however, the signal control process is not limited to this. For example, the CPU 30 may output error information to the transmission source of the signal in step S203, and thereafter, the flow may return to step S201.

As described above, in this exemplary embodiment, the communication control device 2 starts a transfer of a signal different from the first image data 10 and the second image data 12 to the external control device 3 in the case where the enable signal 56 is switched to active.

When it is assumed that a bandwidth necessary for transfer B is larger than a bandwidth necessary for transfer C, if the bandwidth capacity of the communication line 22 is equal to or larger than the sum of the bandwidth necessary for transfer B and a bandwidth necessary for a transfer of a signal different from the first image data 10 and the second image data 12, a transfer of the first image data 10 and a transfer of the second image data 12 are not hindered by a transfer of the signal, regardless of when the signal is transferred to the external control device 3. Therefore, in this case, a transfer of a signal different from the first image data 10 and the second image data 12 to the external control device 3 may be started even in the case where the enable signal 56 is not active.

If the bandwidth necessary for transfer B is equal to or larger than the sum of the bandwidth necessary for transfer C and the bandwidth necessary for a transfer of a signal different from the first image data 10 and the second image data 12, a transfer of the first image data 10 and a transfer of the second image data 12 are not hindered by a transfer of the signal by transferring the signal to the external control device 3 during the period of the inter-page gap 50 in which transfer B is not being performed in accordance with the above-described signal control process.

### Second Exemplary Embodiment

Next, a communication control device and a communication control system according to a second exemplary embodiment are described.

In the above-described first exemplary embodiment, the case where transfer C is started during the period of the inter-page gap 50 is described. In the second exemplary embodiment, a case where transfer C is started during the period of an inter-line gap 60 described below is described.

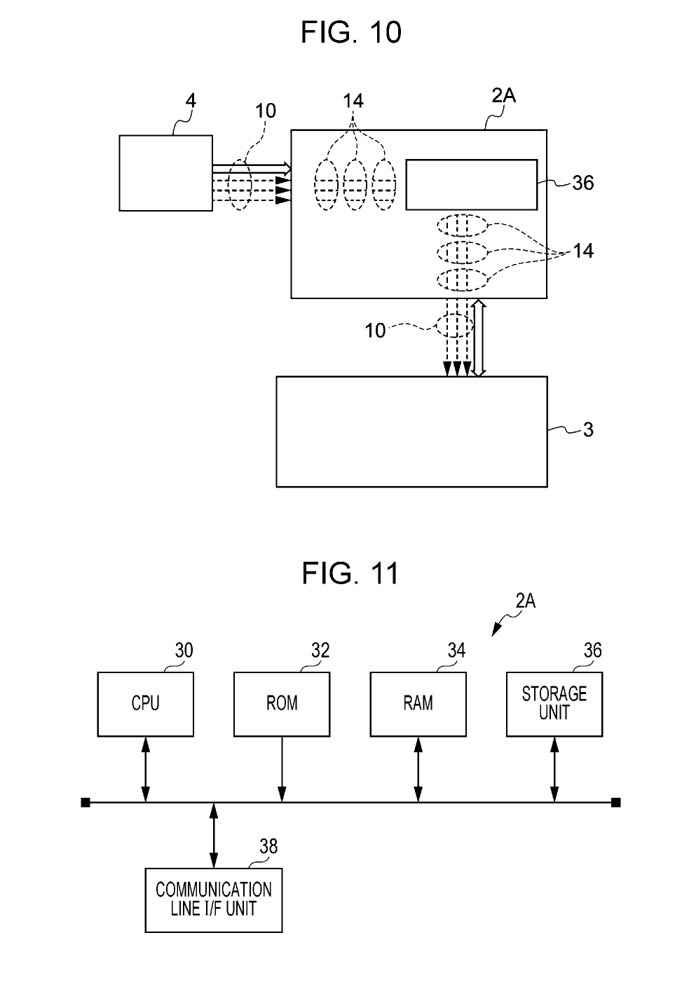

As illustrated in FIG. 10 and FIG. 11, the configuration of a communication control device 2A according to the second exemplary embodiment is the same as that of the communication control device 2 according to the above-described first exemplary embodiment except for a storage unit 36 that is further included in the communication control device 2A. Therefore, description of the individual constituent elements other than the storage unit 36 is omitted. Further, the configuration of the external control device 3 according to the second exemplary embodiment is the same as that of the external control device 3 according to the above-described first exemplary embodiment, and therefore, description of the individual constituent elements is omitted.

The storage unit 36 is an example of a storage unit and is, for example, a RAM (line buffer) that stores data for a predetermined number of lines of the first image data 10.

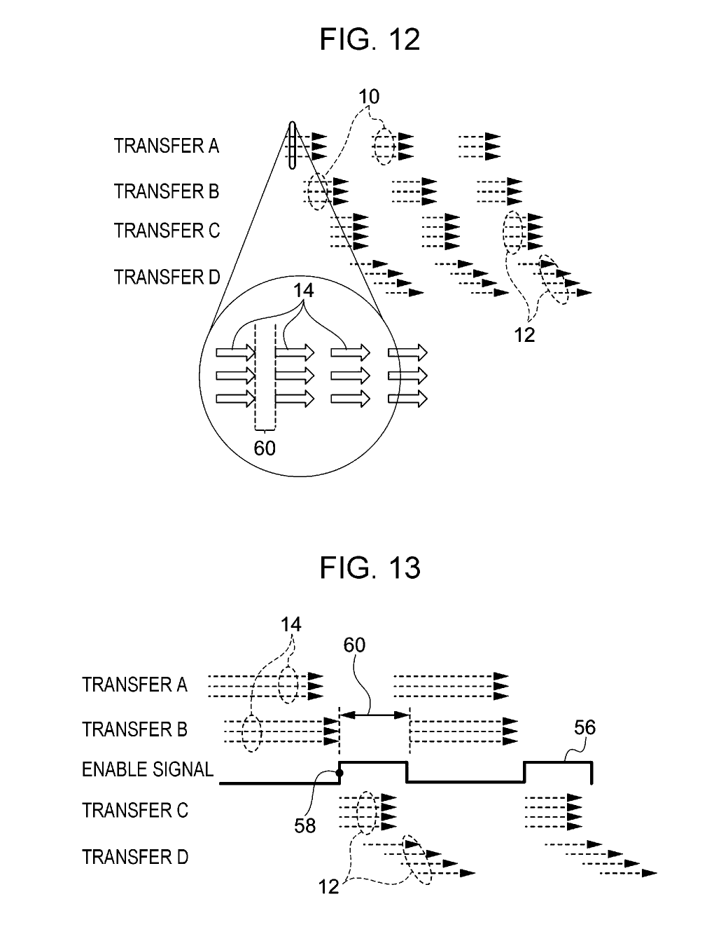

Here, in a case where the image reading device 4 reads each of the images formed on plural recording media for each line, there is a time period during which reading is not being performed in a period from completing reading of an image of one line until starting reading of an image of the next line. Accordingly, there is an interval (hereinafter referred to as “inter-line gap”) 60 during which transfer A is not being performed between pieces of line data 14 of the first image data 10, the pieces of line data 14 corresponding to successive read lines, as illustrated in FIG. 12.

The inter-line gap 60 also exists in transfer B between the communication control device 2A and the external control device 3 in the case where, in the process A in FIG. 2, the first image data 10 from the image reading device 4 is not temporarily stored on the communication control device 2 (the communication control device 2A in this exemplary embodiment), is subjected to only a simple real-time process (for example, shading correction), and is output to the external control device 3. Accordingly, also in transfer B, when the first image data 10 is transferred from the communication control device 2A to the external control device 3 for each of the portions that are predetermined transfer units (in this exemplary embodiment, the transfer units correspond to the lines), the inter-line gap 60 between the portions exists.

In this case, there are a period during which both transfer B and transfer C are performed and a period during which transfer B or transfer C is not performed, as in the first exemplary embodiment, and a load of communication between the communication control device 2A and the external control device 3 increases.

Accordingly, the communication control device 2A makes the enable signal 56 active and outputs the enable signal 56 during the period of the inter-line gap 60 in which data transfer in transfer B is not being performed, as illustrated in FIG. 13. The external control device 3 starts transfer C, that is, data transfer from the external control device 3 to the communication control device 2A, at the timing 58 when the enable signal 56 switches from inactive to active.

Accordingly, control is performed so as to start transfer C during the period in which transfer B is not being performed, as illustrated in FIG. 13, and a load of communication between the communication control device 2A and the external control device 3 is reduced.

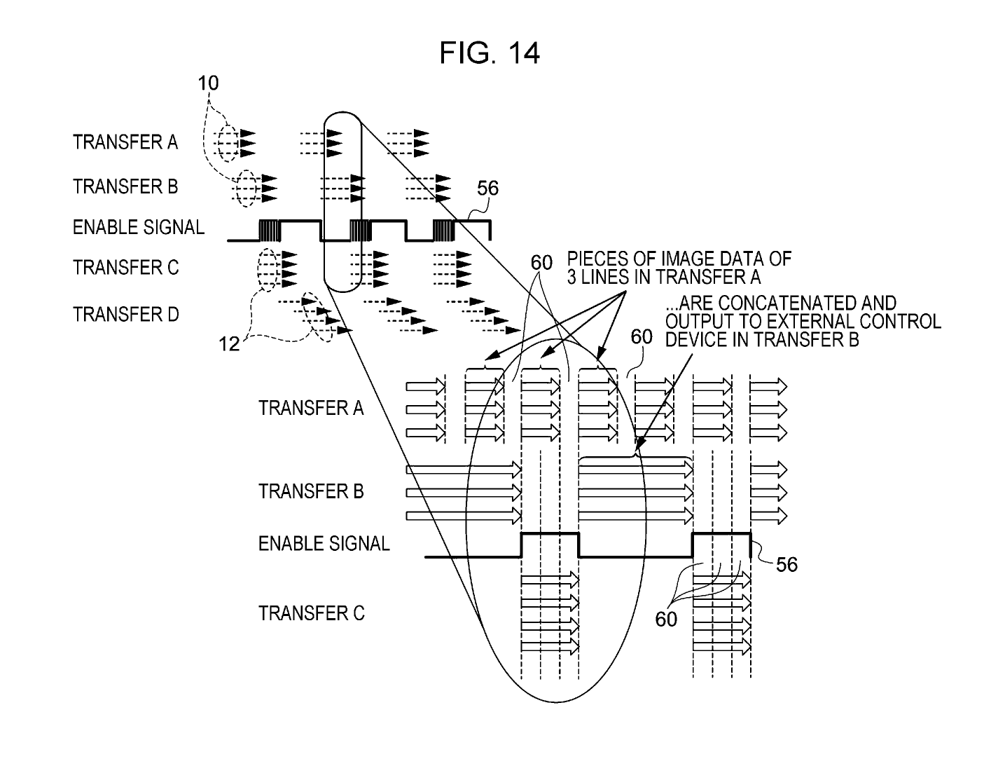

The inter-line gap 60 is a period shorter than the inter-page gap 50 described above. Therefore, in this exemplary embodiment, the communication control device 2A performs a process for temporarily storing the first image data 10 in the storage unit 36, the process being included in the process A illustrated in FIG. 2, thereby concatenating and transferring plural (for example, three) pieces of line data 14 to the external control device 3, as illustrated in FIG. 14. Accordingly, plural (for example, three) inter-line gaps 60 are also concatenated, and a time period during which the enable signal 56 is continuously active increases. The external control device 3 starts transfer C at the timing when the enable signal 56 switches from inactive to active, that is, at the timing when a single gap formed by concatenating the inter-line gaps 60 starts.

As described above, the case where plural inter-line gaps 60 are concatenated is described in this exemplary embodiment; however, this exemplary embodiment is not limited to this. For example, transfer C may be performed in each inter-line gap 60.

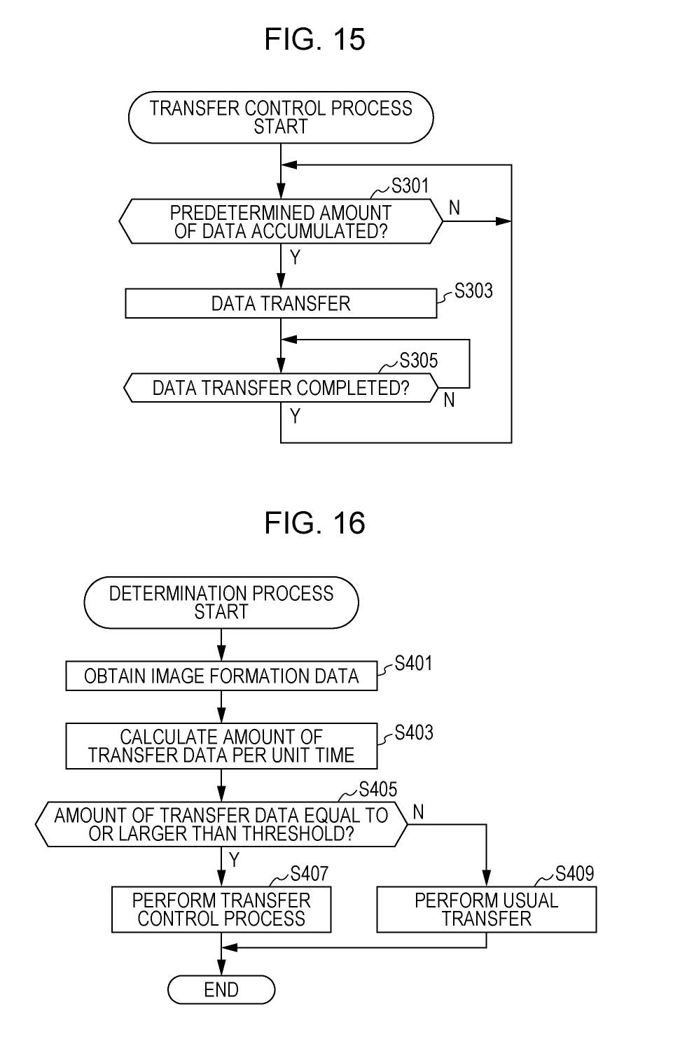

Now, a flow of a transfer control process that is performed by the communication control device 2A according to this exemplary embodiment in a case where a predetermined instruction for performing is input is described with reference to the flowchart in FIG. 15. Note that, in this exemplary embodiment, a program for the transfer control process is stored in advance in the ROM 32; however, the program is not limited to this.

In step S301, the CPU 30 determines whether the first image data 10 for a predetermined amount of data has been accumulated in the storage unit 36. The predetermined amount of data is determined as desired in accordance with the length of the inter-line gaps 60 that are to be concatenated and is, for example, an amount of data that corresponds to the sum of the amounts of pieces of line data 14 of three lines of the first image data 10.

If the CPU 30 determines in step S301 that the first image data 10 for the predetermined amount of data has been accumulated (Y in step S301), the flow proceeds to step S303. If the CPU 30 determines in step S301 that the first image data 10 for the predetermined amount of data has not been accumulated (N in step S301), step S301 is repeated until the CPU 30 determines that the first image data 10 for the predetermined amount of data has been accumulated.

In step S303, the CPU 30 makes the first image data 10 stored in the storage unit 36 be transferred to the external control device 3.

In step S305, the CPU 30 determines whether the transfer started in step S303 is completed. If the CPU 30 determines in step S305 that the transfer is completed (Y in step S305), the flow returns to step S301. If the CPU 30 determines in step S305 that the transfer is not completed (N in step S305), step S305 is repeated until the CPU 30 determines that the transfer is completed.

As described above, in this exemplary embodiment, pieces of data of plural lines of the first image data 10 transferred from the image reading device 4 are stored in the storage unit 36, and the stored pieces of data of plural lines of the first image data 10 are concatenated and output to the external control device 3 as a single piece of data.

### Third Exemplary Embodiment

Now, a communication control device and a communication control system according to a third exemplary embodiment are described.

In the above-described first exemplary embodiment, the case where transfer C is started during the period of the inter-page gap 50 is described. In the above-described second exemplary embodiment, the case where transfer C is started during the period of the inter-line gap 60 is described. In the third exemplary embodiment, a case is described where determination as to whether control is performed so as to start transfer C during the period of the inter-page gap 50 or the inter-line gap 60 is performed on the basis of the amount of transfer data per unit time.

The configuration of the communication control device 2 according to the third exemplary embodiment is the same as that of the communication control device 2 according to the above-described first exemplary embodiment, and therefore, description of the individual constituent elements is omitted. Further, the configuration of the external control device 3 according to the third exemplary embodiment is the same as that of the external control device 3 according to the above-described first exemplary embodiment, and therefore, description of the individual constituent elements is omitted.

Now, a flow of a determination process that is performed by the external control device 3 according to this exemplary embodiment in a case where a predetermined performing instruction is input is described with reference to the flowchart in FIG. 16. Note that, in this exemplary embodiment, a program for the determination process is stored in advance in the storage unit 36A; however, the program is not limited to this. For example, the program for the determination process may be received from an external device via the communication line I/F unit 38A and stored in the storage unit 36A. Alternatively, the program for the determination process recorded to a recording medium, such as a CD-ROM, may be read by, for example, a CD-ROM drive to thereby perform the determination process.

In step S401, the CPU 30A obtains image formation data that includes an instruction for image formation, conditions for image formation, and so on. The image formation data includes data that indicates the speed at which the recording medium is conveyed in image reading or image formation, the solution of the image in image reading or image formation, the size of the recording medium and the enlargement or reduction ratio of the image in image reading or image formation, whether the image is a color image or a monochrome image, the gradation of the image in image reading or image formation, whether single-sided image reading or image formation or double-sided image reading or image formation is performed, the number of images (the number of pages) formed on one recording medium, and so on.

In step S403, the CPU 30A calculates the amount of transfer data per unit time in transfer B and the amount of transfer data per unit time in transfer C on the basis of the obtained image formation data.

In step S405, the CPU 30A determines whether the total amount of transfer data, which is the sum of the calculated amounts of transfer data, is equal to or larger than a predetermined threshold. The predetermined threshold is, for example, the maximum transfer capacity per unit time of a bidirectional transfer path that connects the communication control device 2 and the external control device 3 with each other.

If the CPU 30A determines in step S405 that the total amount of transfer data is equal to larger than the predetermined threshold (Y in step S405), the flow proceeds to step S407. If the CPU 30A determines in step S405 that the total amount of transfer data is smaller than the predetermined threshold (N in step S405), the flow proceeds to step S409.

In step S407, the CPU 30A performs control so as to start transfer C during the period of the inter-page gap 50 or the inter-line gap 60.

In step S409, the CPU 30A performs control so as to start transfer C as needed, regardless of the period of the inter-page gap 50 or the inter-line gap 60.

As described above, in this exemplary embodiment, in the case where the total amount of data transferred between the communication control device 2 and the external control device 3 is smaller than the maximum transfer capacity per unit time of the bidirectional transfer path connecting the communication control device 2 and the external control device 3, the communication control device 2 starts obtaining the second image data 12 transferred from the external control device 3 as needed.

In the above-described exemplary embodiments, the case where the communication control system 1 is an image forming system that includes the communication control device 2, the external control device 3, the image reading device 4, and the image forming device 5 is described; however, the communication control system 1 is not limited to this. For example, the communication control device 2, the external control device 3, the image reading device 4, and the image forming device 5 may be separately provided and connected to one another.

In the exemplary embodiments, the case is described of using the enable signal that is inactive during a period in which a transfer from the communication control device 2 to the external control device 3 is being performed; however, the signal used is not limited to this. A signal that is active during the period in which a transfer from the communication control device 2 to the external control device 3 is performed may be used. In this case, during a period in which the signal is active, communication from the external control device 3 to the communication control device 2 is not allowed. That is, the external control device 3 starts transfer C, that is, a transfer of the second image data 12 from the external control device 3 to the communication control device 2, at the timing when the signal switches from active to inactive.

The configurations of the communication control devices 2 and 2A and the external control device 3 described in the above-described exemplary embodiments (see FIG. 1 to FIGS. 3A and 3B, FIG. 5, FIG. 8, FIG. 10, and FIG. 11) are examples. An unnecessary portion may be deleted from any of the configurations or a new portion may be added to any of the configurations without departing from the spirit of the exemplary embodiments of the present invention as a matter of course.

Further, the program flows of the processes described in the above-described exemplary embodiments (see FIG. 7, FIG. 9, FIG. 15, and FIG. 16) are examples. An unnecessary step may be deleted from any of the program flows, a new step may be added to any of the program flows, or the order in which steps are performed may be changed without departing from the spirit of the exemplary embodiments of the present invention as a matter of course.

In the exemplary embodiments, the inter-page gap 50 and the inter-line gap 60 are described as examples of the interval between portions that are the predetermined transfer units; however, the interval is not limited to this. The exemplary embodiments of the present invention are applied to an interval between portions that are any transfer units of image data processed as a single piece of data.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A communication control device comprising:
a communication unit that transfers first image data obtained from a first processing device to an external control device for each portion among portions that are predetermined transfer units, and transfers second image data transferred from the external control device to a second processing device, the communication control device and the external control device being included in a system and being connected to each other via a communication line for half-duplex communication;
a reception unit that receives a signal that is transmitted during an interval between the portions of the first image data; and
a controller that performs control so as to start obtaining the second image data transferred from the external control device in a case where the signal is received by the reception unit.

2. The communication control device according to claim 1, wherein
the interval between the portions is an interval between a plurality of successive recording media in a case of successively reading images formed on the recording media, or an interval between successive lines in a case of reading an image formed on a recording medium for each of the lines.

3. The communication control device according to claim 1, further comprising
a storage unit that stores the first image data, wherein
the communication unit stores a plurality of pieces of data that are the transfer units of the first image data transferred from the first processing device in the storage unit, and concatenates and outputs the plurality of pieces of data, which are the transfer units and which are stored, to the external control device as a single piece of data.

4. The communication control device according to claim 2, further comprising
a storage unit that stores the first image data, wherein
the communication unit stores a plurality of pieces of data that are the transfer units of the first image data transferred from the first processing device in the storage unit, and concatenates and outputs the plurality of pieces of data, which are the transfer units and which are stored, to the external control device as a single piece of data.

5. The communication control device according to claim 1, wherein
in a case where the controller transfers data other than the first image data to the external control device, the controller starts transferring the data during the interval between the portions.

6. The communication control device according to claim 2, wherein
in a case where the controller transfers data other than the first image data to the external control device, the controller starts transferring the data during the interval between the portions.

7. The communication control device according to claim 3, wherein
in a case where the controller transfers data other than the first image data to the external control device, the controller starts transferring the data during the interval between the portions.

8. The communication control device according to claim 4, wherein
in a case where the controller transfers data other than the first image data to the external control device, the controller starts transferring the data during the interval between the portions.

9. The communication control device according to claim 1, wherein
the signal is not transmitted during a period in which the communication unit is transferring data other than the first image data to the external control device.

10. The communication control device according to claim 2, wherein
the signal is not transmitted during a period in which the communication unit is transferring data other than the first image data to the external control device.

11. The communication control device according to claim 3, wherein
the signal is not transmitted during a period in which the communication unit is transferring data other than the first image data to the external control device.

12. The communication control device according to claim 4, wherein
the signal is not transmitted during a period in which the communication unit is transferring data other than the first image data to the external control device.

13. The communication control device according to claim 5, wherein
the signal is not transmitted during a period in which the communication unit is transferring data other than the first image data to the external control device.

14. The communication control device according to claim 6, wherein
the signal is not transmitted during a period in which the communication unit is transferring data other than the first image data to the external control device.

15. The communication control device according to claim 7, wherein
the signal is not transmitted during a period in which the communication unit is transferring data other than the first image data to the external control device.

16. The communication control device according to claim 8, wherein
the signal is not transmitted during a period in which the communication unit is transferring data other than the first image data to the external control device.

17. The communication control device according to claim 1, wherein
in a case where a total amount of data transferred between the communication control device and the external control device is smaller than a maximum transfer capacity per unit time of a bidirectional transmission path connecting the communication control device and the external control device with each other, the controller starts obtaining the second image data transferred from the external control device as needed.

18. A communication control system comprising:
the communication control device according to claim 1; and
an external control device that transfers to the communication control device second image data generated by processing first image data transferred from the communication control device.
